(19) United States
(12) Patent Application Publication
(10) Pub. No.: US 2014/0375572 A1
(43) Pub. Date: Dec. 25, 2014

(54) PARAMETRIC MOTION CURVES AND MANIPULABLE CONTENT

(71) Applicant: Microsoft Corporation, Redmond, WA (US)

(72) Inventors: Perumaal Shanmugam, Mercer Island, WA (US); Nicolas Brun, Seattle, WA (US); Nicholas Waggoner, Newcastle, WA (US); Yin Yin, Bellevue, WA (US)

(21) Appl. No.: 13/923,206

(22) Filed: Jun. 20, 2013

(51) Int. Cl. G06F 3/041

(52) U.S. Cl. CPC G06F 3/041
USPC 345/173

(57) ABSTRACT

Motion of manipulable content in response to input, such as touch input from a user can be defined by criteria set forth by parametric equations. An application that generates manipulable content can be tailored so that the manipulable content responds in a particular way to the input. A programmer can perform such tailoring by providing parametric equations as input to the application. A set of parametric equations can be applied to an input transform to generate an output transform, which can be used to affect motion of manipulable content as represented on an associated display, such as a touch screen display.

### BACKGROUND

Many computing devices utilize touch surfaces, such as touch pads and touch screens. These touch surfaces receive input from a user or item that causes the computing device to perform an action, such as selecting an icon, scrolling through a page, manipulating displayed content, and so on.

Typically, third party programmers of an application generally control output motion (e.g., in response to touch input) of manipulable content as a function of time or as an implicit, predefined function written in the application. Thus, changing the motion or describing the motion of manipulable content as a function of touch input requires adding new code to the application.

### SUMMARY

This disclosure describes, in part, techniques and architectures for describing parametric curves and associating the parametric curves with manipulable content of a display. Parametric curves can transform an input manipulation/inertia transform matrix into an output transform matrix for manipulable primary content and for manipulable secondary content. Individual components (e.g., translation, scale, and so on) of an input transform matrix can be evaluated using parameterized curves and transformed into associated components of an output transform matrix. In this fashion, a programmer can describe desired motion of manipulable content using parametric curves, which can be applied to an input transform matrix of primary and/or secondary manipulable content asynchronously, at a later time.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs)), and/or technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 shows an example display, e.g., touch display, to illustrate features of manipulable content, according to various embodiments.

FIG. 3 is a block diagram illustrating operation flow for modifying manipulable content, according to various embodiments.

FIG. 4 is a block diagram illustrating curve evaluation for modifying manipulable content, according to various embodiments.

FIG. 5 shows a plot of output values for a component of an output transform matrix as a function of input values of the corresponding component of an input transform matrix, according to various embodiments.

FIG. 6 is a flow diagram of a process for modifying manipulable content, according to various embodiments.

FIG. 7 is a flow diagram of a process for modifying manipulable content, according to various embodiments.

FIG. 8 is a flow diagram of a process for modifying manipulable content, according to various embodiments.

### DETAILED DESCRIPTION

### Overview

In various embodiments, techniques and devices allow manipulable content to be manipulated according to criteria defined by parametric equations. Manipulable content, which includes graphical elements of a display, can be manipulated by a user operating touch screen, a touch pad, or any other type of digitizer configured to receive touch or indirect input such as gestural input. Parametric equations can govern how manipulable content responds to such input. Although the techniques described herein are introduced with regard to touch input devices such as direct touch input devices, e.g., touch screens, or indirect input devices, e.g., touch pads, the techniques are equally applicable to other indirect input devices, e.g., non-touch indirect input devices. Whether in direct touch, indirect touch, or other indirect input environments, the techniques can determine one or more of a variety of parameters of the input (e.g., contact from objects on a detection area such as a surface or detection of objects within a detection area) received by the input device, can convert the input into a coordinate space associated with a display screen, and can govern how manipulable content responds to the input.

In various embodiments, a user interacts with features of an application via a touch input device. The application generates manipulable content that is displayed on an associated display (e.g., a touch surface display). Such manipulable content can include tables, listings, buttons, sliders, text, graphics, images, and so on. Via touch contact, a user can pan, zoom, rotate, and swipe such elements of manipulable content. In some embodiments, an application can be tailored so that manipulable content responds in a particular way to touch contact by a user. For example, a programmer can perform such tailoring by providing parametric equations as input to the application. By tailoring the application using parametric equations, a programmer need not modify the application itself to change how the application responds to touch contact of manipulable content. Accordingly, during execution, the application can apply the parametric curves to transform touch input of manipulable content into particular pre-defined response behavior of the manipulable content.

In various embodiments, a method for defining behavior of manipulable content of an application can include applying a set of parametric equations to an input transform to generate an output transform. Such input and output transforms can include matrices that include components of position and/or motion of manipulable content. For example, an input transform can be responsive to touch input from an input device. Such an input device can include a touch-based device, a touchpad device, a mouse, a keyboard, or another device that allows a user to control motion of an object on an output display device.

In another example, an input transform can be based, at least in part, on time-based animation behavior while there is no physical contact between a user and the input device. Thus, applying a set of parametric equations to such an input transform can define animation behavior of manipulable content of an application.

The parametric equations represent pre-defined behavior of the manipulable content. Executable code can generate the parametric equations based, at least in part, on parameters provided by a programmer who desires to define behavior of the manipulable content. The generated output transform affects motion of the manipulable content of an input device during execution of the application.

In some embodiments, multiple pre-defined behaviors of the manipulable content can be chained together so that an output transform of one of the multiple pre-defined behaviors becomes an input transform for a next one of the multiple pre-defined behaviors. In other words, pre-defined behaviors can be applied in a sequential fashion.

Manipulable content can include primary content and secondary content. Pre-defined behavior of secondary content responsive to an input device can be applied to a final output transform of chained multiple pre-defined behaviors of the primary content. Motion of the secondary manipulable content can be affected based, at least in part, on the applied pre-defined behavior of the secondary content.

In various embodiments, a system can include an input device to receive a touch contact from a user, one or more processors communicatively coupled to the input device, memory communicatively coupled to the one or more processors, and a direct manipulation (DM) module stored in the memory and executable by one or more processors. The input device can include or be associated with at least one of a touch pad or a touch screen.

A DM module allows asynchronous and synchronous control of an output device image generated by a program and/or executable code as a function of input from an input device or as a function of a time-based animation based on the input. The DM module can apply a set of parametric equations to an input transform to generate an output transform, thus affecting motion of manipulable content on a display associated with the input device based, at least in part, on the output transform. The DM module can chain multiple pre-defined behaviors of manipulable content so that an output transform of one of the multiple pre-defined behaviors becomes an input transform for a next one of the multiple pre-defined behaviors. Moreover, the DM module can apply a pre-defined behavior of secondary content to a final output transform of the chained multiple pre-defined behaviors of the primary content. In this fashion, the DM module can affect motion of the secondary content based, at least in part, on the applied pre-defined behavior of secondary manipulable content.

In various embodiments, a DM module, other executable code, and/or hardware logic can define behavior of manipulable content of an application. The DM module, executable code, and/or hardware logic can receive one or more descriptions of motion for primary content of manipulable content from an application programming interface (API), an application, a programmer, and/or a portion of the DM module. For example, descriptions of motion can be exposed by an API, generated by an application, provided by a programmer, and/or generated by a portion of the DM module. The one or more descriptions of motion can each include parametric equations.

A DM module receives touch input from an input device and generates an input manipulation transform based, at least in part, on the touch input. The one or more descriptions of motion correspond to pre-defined behaviors, which the DM module can apply in a sequential fashion, as follows. The DM module applies a first of the one or more descriptions of motion to the input manipulation transform to generate a first output transform. Next, the DM module applies a second of the one or more descriptions of motion to the first output transform to generate a second output transform. Next, the DM module applies a third of the one or more descriptions of motion to the second output transform to generate a third output transform, and so on, until the DM module generates a final output transform. Accordingly, the primary content can be affected based, at least in part, on the final output transform.

In some embodiments, the DM module receives descriptions of motion for each of one or more secondary contents of the manipulable content, and applies the descriptions of motion for each of the one or more secondary contents of the manipulable content to the final output transform to respectively generate a set of output transforms that affect the one or more secondary contents.

In various embodiments, the DM module can apply one or more descriptions of motion for primary content asynchronously with receiving the input manipulation transform. For example, a DM module can receive the one or more descriptions of motion and retain them in memory for future use, when they can be applied to a newly received input manipulation transform based on real-time touch input. The DM module (or other entity performing the method) can modify the one or more descriptions of motion stored in memory at any future time. For example, a programmer may desire to re-define motion of manipulable content. In such a case, a DM module can modify the one or more descriptions of motion stored in memory based, at least in part, on parameters provided by the programmer. In another example, pre-defined motion of manipulable content can be time-based, and thus can change over time. In such a case, a DM module can modify the one or more descriptions of motion stored in memory based, at least in part, on elapsed time, a calendar event, and so on. In yet another example, a DM module can modify the one or more descriptions of motion stored in memory based, at least in part, on manipulation of the manipulable content itself.

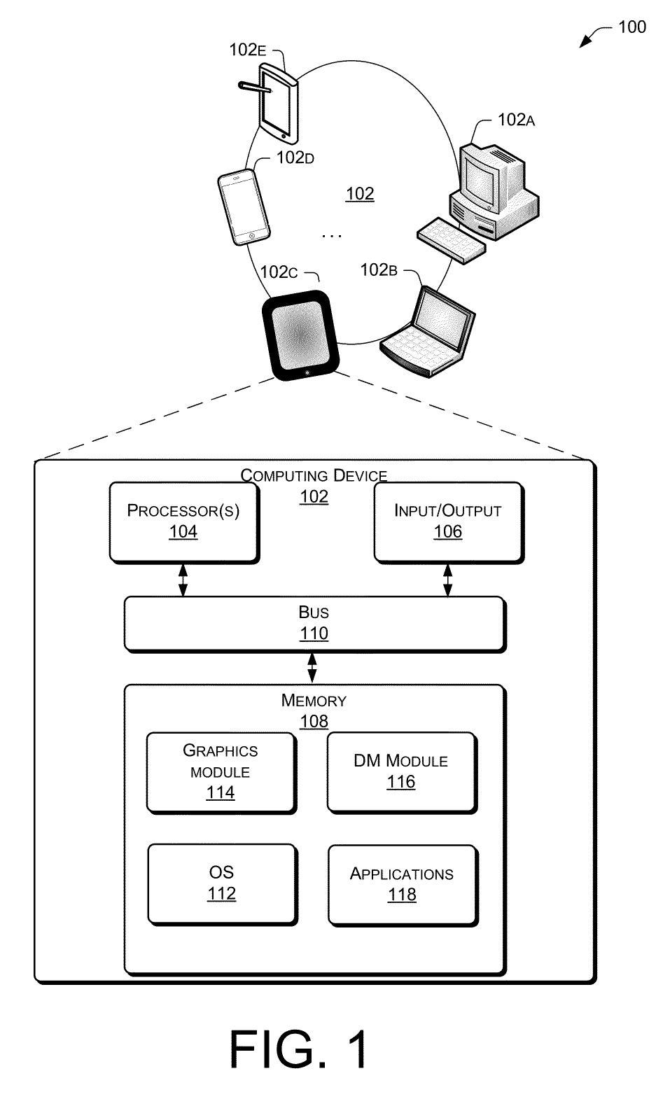

Various embodiments are described further with reference to FIGS. 1-8.

### Illustrative Environment

The environment described below constitutes but one example and is not intended to limit the claims to any one particular operating environment. Other environments may be used without departing from the spirit and scope of the claimed subject matter. FIG. 1 shows an example environment 100 in which embodiments involving manipulable content as described herein can operate. In some embodiments, the various devices and/or components of environment 100 include a variety of computing devices 102. In various embodiments, computing devices 102 include devices 102A-102F. Although illustrated as a diverse variety of device types, computing devices 102 can be other device types and are not limited to the illustrated device types. Computing devices 102 can include any type of device with one or multiple processors 104 operably connected to an input/output interface 106 and memory 108 via a bus 110. Computing devices 102 can include personal computers such as, for example, desktop computers 102A, laptop computers 102B, tablet computers 102c, telecommunication devices 102D, personal digital assistants (PDAs) 102E, electronic book readers, wearable computers, automotive computers, and/or gaming devices. Computing devices 102 can also include business or retail oriented devices such as, for example, server computers, thin clients, terminals, and/or work stations. In some embodiments, computing devices 102 can include, for example, components for integration in a computing device, appliances, or another sort of device.

In some embodiments, as shown regarding device 102c, memory 108 can store instructions executable by the processor(s) 104 including an operating system 112, a graphics module 114, a DM module 116, and programs or applications 118 that are loadable and executable by processor(s) 104. The one or more processors 104 may include a central processing unit (CPU), graphics processing unit (GPU), a microprocessor, and so on. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The memory 108 may include one or a combination of computer readable media. Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media. For example, memory 108 and the described computer storage media encompassed thereby do not include communications media consisting solely of propagated signals, per se.

In various embodiments, memory 108 can include a computer storage medium storing computer-executable instructions that, when executed by processor(s) 104, configure the processor(s) to control a display (e.g., of input/output 106) by controlling communication between DM module 116 and graphics module 114. In some embodiments, DM module 116 stored in memory 108 and executable by processor(s) can apply a set of parametric equations to an input transform to generate an output transform, and provide instructions to graphics module 114 to affect represented motion of manipulable content on a display of a device such as an input device (e.g., of input/output 106) based, at least in part, on the output transform. An input device can include any of a variety of devices that are intended to provide and/or imply motion to an object presented visually on an output device. For example, in various embodiments an input device can be a direct-touch input device, e.g., a touch screen, an indirect-touch device, e.g., a touch pad, an indirect input device, e.g., a mouse, keyboard, a camera or camera array, etc., or another type of non-tactile device, such as an audio input device.

Computing device(s) 102 can include one or more input/output (I/O) interfaces 106 to allow a computing device 102 to communicate with other devices. Input/output (I/O) interfaces 106 can also include one or more network interfaces to enable communications between computing device 102 and other networked devices such as other device(s) 102. Input/output (I/O) interfaces 106 can allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

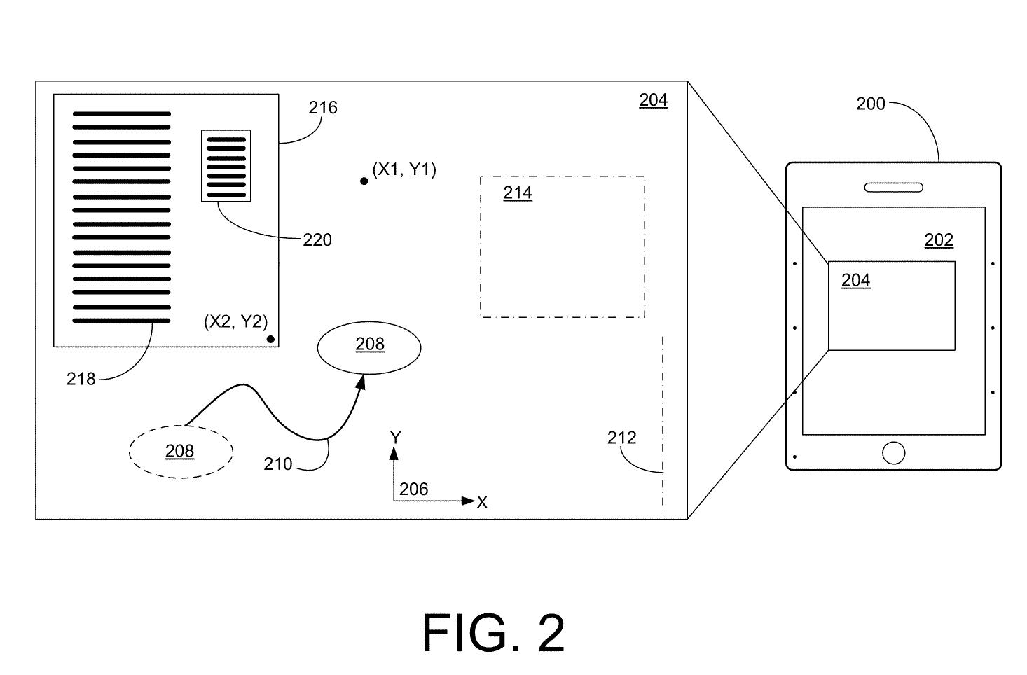

FIG. 2 shows a computing device 200 that includes a display 202 to illustrate features of manipulable content, according to various embodiments. Computing device 200 can include a desktop computer, laptop computer, tablet computer, telecommunication device, PDA, electronic book readers, and so on. Display 202 can include a touch screen. Display 202 can also be associated with a touch pad or any other type of digitizer configured to receive touch or other indirect input.

For illustrative purposes, display 202 includes a region 204 that is shown in detail to the left in FIG. 2. X-Y axes 206 are included in region 204 for reference in the descriptions that follow. Region 204 includes a number of graphical elements comprising manipulable content that can be moved or dragged by a user. For example, manipulable content includes an object 208 that can follow a user's finger, as indicated by arrow 210. Object 208 can include, among other things, a button, text, a table, a thumbnail photo, or a window. In other portions of region 204, however, object 208 need not follow a user's finger, but may instead follow a constrained motion. For example, a boundary 212 may prevent object 208 from following a user's finger in an X-direction beyond the boundary. In another example, regardless of a user's finger movement, behavior of motion of object 208 can depend on whether object 208 is in a region 214 or outside region 214. In yet another example, a point (X1, Y1) can influence motion of object 208 regardless of a user's finger movement: For example, object 208 may be drawn toward point (X1, Y1) when object 208 is in a relatively close proximity to the point, which can act as a gravity well. Another example object in region 204 can include a window 216 to which a user can impart motion by dragging the window to other portions of region 204. Such motion, however, can be affected by elements such as point (X1, Y1), boundary 212, and region 214, as in the case for object 208.

In an example embodiment, window 216 includes list 218 and index 220. For example, list 218 can include a phone number listing of businesses, and index 220 can include the alphabet to allow for quick searches through list 218 (e.g., list 218 can “jump” to a particular letter selected in index 220). To describe a concept that can apply to manipulable content in general, list 218 and index 220 can be considered to be primary content and secondary content, respectively. Secondary content includes manipulable content whose motion (e.g. imparted by touch contact from a user) depends, at least in part, on motion of primary content. On the other hand, primary content motion is independent of secondary content motion. Thus, for example, a user swiping list 218 in the Y-direction to scan through a list of phone numbers causes the entire contents of window 216 to pan upward. Index 220, being secondary content, can maintain its position during such panning relative to a stationary point (X2, Y2) of window 216. Index 220, however, can momentarily follow the panning motion as if connected to a stretching spring, and subsequently bounce back to its original position after panning stops.

Manipulable content can include primary content and multiple secondary contents. Using the case above, additional secondary contents can include individual elements of index 220 that respond to particular portions of list 218 displayed during panning or scrolling. For example, index 220 can include a virtual part of list 218 that is displayed at the top of list 218. Index 220 can present an index entry until panning or scrolling through list 218 reaches a portion associated with a subsequent index entry. When this occurs, index 220 can present the subsequent index entry in place of the earlier index entry.

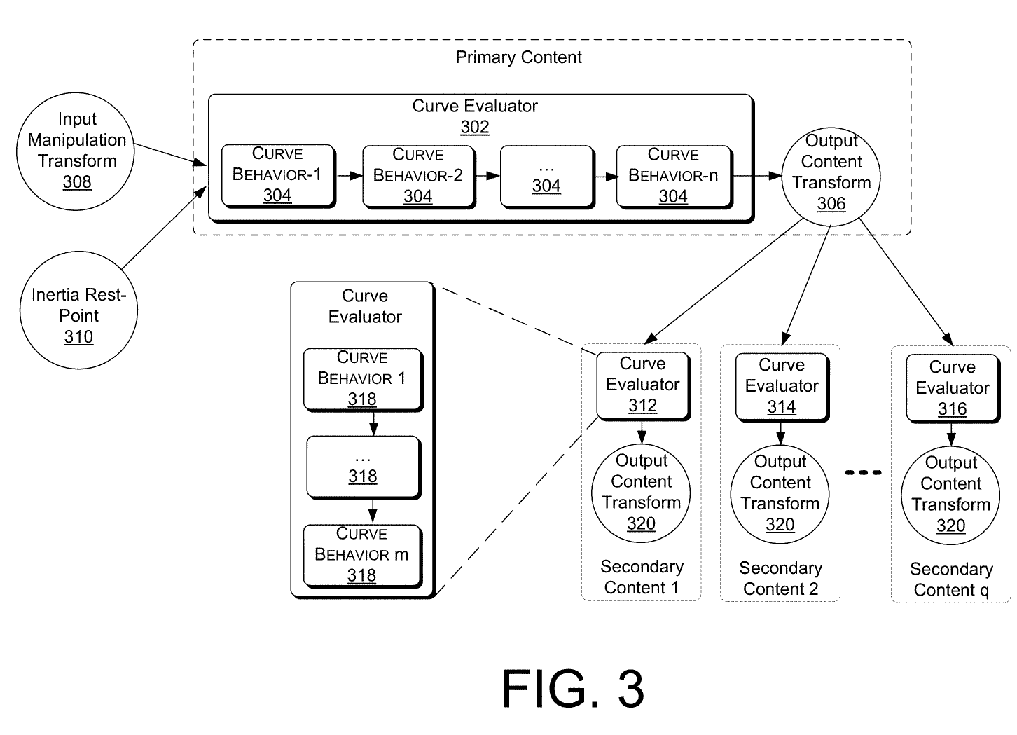

FIG. 3 is a block diagram illustrating operation flow for modifying manipulable content, according to various embodiments. As mentioned above, motion of manipulable content in response to input, such as touch input, by a user can be defined by criteria set forth by parametric equations. In particular, an application that generates manipulable content can be tailored so that the manipulable content responds in a particular way to touch by a user. For example, a programmer can perform such tailoring by providing parametric equations as input to the application. In various embodiments, such parametric equations can be passed from a client (e.g., an API) to the application as parametric curve behavior objects associated with manipulable content. Parametric curve behavior objects can define an association between input transform components and output transform components that the parametric curve behavior objects use as input and output, respectively. As explained below, the parametric curve behavior objects can be copied and stored by a DM module associated with the application, thus allowing the parametric curve behavior objects to be later applied asynchronously during input manipulation or during inertial motion of manipulable content.

In various embodiments, a DM module includes a curve evaluator 302 that applies one or more parametric curve behavior objects 304 to input, such as touch input, and generates an output content transform 306. In particular, curve evaluator 302 is directed to input, such as touch input, of primary content. Accordingly, one or more parametric curve behavior objects 304 are directed to defining motion of primary content.

Input, such as touch input, can be represented by an input manipulation transform 308 that includes a plurality of components and can be expressed as a matrix. An inertia rest-point 310 can similarly include a plurality of components that represent how motion of manipulable content behaves after input, such as touch input, ceases (e.g., a user lifts their finger(s) from a touch surface). Thus, for example, curve evaluator 302, by applying one or more parametric curve behavior objects 304, can define an association between input, such as touch input, and content output. Curve evaluator 302 applies one or more parametric curve behavior objects 304 in a sequential fashion, so that an output transform of one curve behavior object 304 is an input of the next curve behavior object, and so on. For example, curve evaluator 302 applies curve behavior-1 object 304 to input manipulation transform 308 and thus generates an output transform. Curve evaluator 302 then applies curve behavior-2 object 304 to this output transform to generate another output transform, and so on. In other words, an output transform generated by applying a curve behavior object to an input transform is itself an input transform for a subsequent curve behavior object. Finally, curve evaluator 302 applies curve behavior-n object 304 to the next-to-last output transform to generate output content transform 306, which affects the behavior of primary content. This process includes a post-processing method that affects the output content transform alone, and need not affect input manipulation or inertia transforms.

In various embodiments, output content transform 306 can be separately applied to one or more secondary contents. In this fashion, motion of secondary content is at least partially dependent on motion of primary content. A DM module includes one or more curve evaluators 312-316 directed to input, such as touch input, of secondary content. Curve evaluators 312-316 apply one or more parametric curve behavior objects 318 to output content transform 306, which is based, at least in part, on primary content motion and behavior. The one or more parametric curve behavior objects 318 are directed to defining motion of each of one or more secondary contents.

Curve evaluators 312-316, by applying one or more parametric curve behavior objects 318, can define an association between primary content input (e.g., motion and/or response) and secondary content output. Curve evaluators 312-316 apply one or more parametric curve behavior objects 318 in a sequential fashion, so that an output transform of one curve behavior object 318 is an input of the next curve behavior object, and so on. For example, curve evaluator 312 for secondary content 1 applies curve behavior-1 object 318 to output content transform 306 and thus generates an output transform. Curve evaluator 312 then applies the next curve behavior object 318 to this output transform to generate another output transform, and so on. Finally, curve evaluator 312 applies curve behavior-n object 318 to the next-to-last output transform to generate output content transform 320, which affects the behavior of secondary content 1. Such a process is similar for secondary content 2 through secondary content q.

In some embodiments, parametric curve behavior objects are applied only during active input manipulation on manipulable content. Active input manipulation occurs while a user selects, touches, and/or drags an object, e.g., with a finger, pen, stylus, etc., after which inertia animation may follow. For example, motion of an object displayed on a screen, such as a touch screen, can continue after a user drags the object with a finger and then lifts the finger off the screen. The continuing motion that follows is called inertia animation. Such continuing motion can have a time dependency that sets forth one or more rest-points. During inertia animation, one or more inertia rest-points 310 can be computed based, at least in part, on any inertia behavior(s) associated with the manipulable content. These rest-points can be passed to curve evaluator 302 to compute final rest-points based, at least in part, on curve behavior objects 304. For example, curve behavior objects 304 can be applied to components of inertia rest-point 310 in a similar fashion to how curve behavior objects 304 are applied to input manipulation transform 308. A final rest-point(s) can be used as an end-point(s) to create an inertial animation that is time-based rather than a parameter of input manipulation (e.g., of transform 308). Thus, during inertial animations, user manipulation behaviors need not be evaluated. If the inertia animation is interrupted abruptly, such as when a user re-applies touch contact, a new input manipulation transform can be computed using an inverse of the current output transform of the inertia animation based, at least in part, on the curve behavior objects 304. Such a process provides a seamless transition from input manipulation to inertia animation and vice versa without jumps or flickers of displayed content.

Curve evaluators 312-316 can apply curve behavior objects 318 for secondary content during both an input manipulation phase (e.g., during touch screen contact) as well as an inertia phase (e.g., during non-contact with the touch screen). Accordingly, secondary content acts as a reflex-behavior to the primary content.

Zoom manipulation of manipulable content can generate a number of parameters that define characteristics of the zoom manipulation. For example, such parameters can include a zoom-center, zoom-factors (e.g., scaling parameters), skew components, rotation components, and translation components. Zoom parameters can be incorporated into input manipulation transform 308. During zoom-manipulation, curve evaluator 302 can first apply curve behavior objects 304 to zoom-center and zoom-factors of the input manipulation transform 308. Next, curve evaluator 302 can apply curve behavior objects 304 to rotation and skew components. Finally, curve evaluator 302 can apply curve behavior objects 304 to translation components. Accordingly, output content transform 306 includes a combination of individual transform matrices based, at least in part, on the separate application of curve behavior objects 304 on the zoom parameters. This process allows for distinguishing translation components due to zoom (e.g., represented by zoom-center) from any translation ‘panning’ components.

An image object can sometimes be located in a display so that edges of the object include fractional pixels. Pixel-snapping is a rendering technique that avoids rendering objects involving such fractional offsets so that the image to be rendered has a one-to-one relationship with the pixels on the display device. Pixel-snapping involves moving edges of an object so that the edges lie at an integral pixel offset instead of at a fractional pixel offset. In some embodiments, when output motion of secondary content follows output motion of primary content with a one-to-one relationship, any fractional pixel offsets are rounded in translation components of transforms of primary content generated by curve evaluator 302. For example, in the case of such a one-to-one relationship, if primary content moves horizontally by 5 units, the secondary content also moves horizontally by 5 units. However, when secondary content does not move one-to-one with primary content, any fractional pixel offsets are not rounded with the primary content's pixel snapping rounding rules. Instead, a default rounding rule on the secondary content is used (e.g., no rounding). This helps ensure that the secondary content and primary content have crisp text and image rendering during input manipulation, when they react to input manipulation in the same way (e.g., move one-to-one with each other).

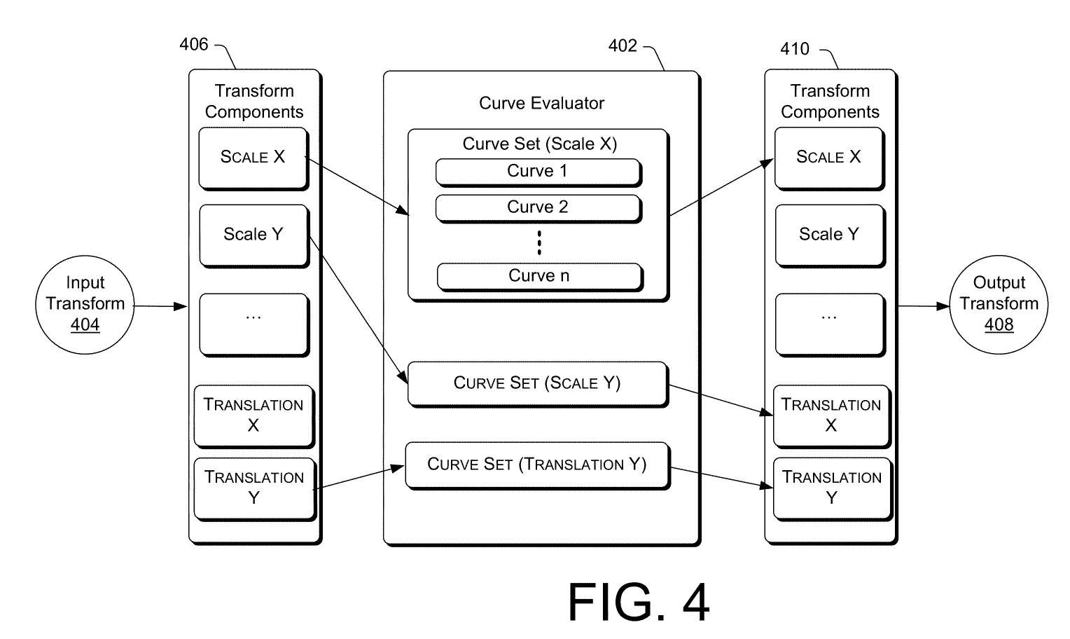

FIG. 4 is a block diagram illustrating curve evaluation for modifying manipulable content, according to various embodiments. Curve evaluator block 402 shows some detail that can be included in curve evaluators 302 and 312-316 of FIG. 3. For example, curve evaluator block 402 includes a plurality of curve sets that correspond to curve behavior objects 304 or 318, depending on whether curve evaluator block 402 is directed to primary content or secondary content. Accordingly, such curve sets may include parametric equations, as described above. Curve sets may include curve sets for scale X, scale Y, translation X, translation Y, and so on. Individual curve sets can further include a plurality of curve portions, such as the curve portions labeled curve 1, curve 2 . . . and curve n for the scale X curve set. In some embodiments, the plurality of curve portions can be combined into a single composite curve, as explained below.

An input transform 404 can include a number of transform components, such as those shown in block 406. Such an input transform may be the same as input manipulation transform 308 shown in FIG. 3. Similarly, input transform 404 may be the same as any input transform to which curve behavior objects 304 are applied. In particular, input transform 404 can include a manipulation transform in the case of primary content, or can include the primary content's output transform in the case of secondary content. Transform components can include elements sufficient to at least partially describe a position and/or motion of manipulable content. Such components may include scale X, scale Y, translation X, translation Y, and so on.

In a component-by-component basis, curve sets of curve evaluator block 402 can be applied to input transform 404. For example, the scale X curve set can be applied to the scale X component of the input transform. Similarly, the scale Y curve set can be applied to the scale Y component of the input transform, and the translation Y curve set can be applied to the translation Y component of the input transform, as indicated by arrows in FIG. 4. Parametric curves can be defined as a mapping between two different properties. For example, a curve can be defined to have translation-y component as input and scale X or scale Y components as the output. Such mapping between two different properties need not affect order of curve evaluation. For example, zoom can be evaluated first as output of input translation Y (as opposed to output translation Y). This same evaluation can be used to transform any inertial animation rest-points as well, by evaluating the individual rest-point components using this same method.

An output transform 408 can include a number of transform components, such as those shown in block 410. Such an output transform may be the same as output content transform 306 shown in FIG. 3. Similarly, output transform 408 may be the same as any output transform generated by applying a curve behavior object 304 to and input transform. Transform components may include elements sufficient to at least partially describe an output position and/or motion of manipulable content. Such components may include scale X, scale Y, translation X, translation Y, and so on. Such output components can be generated by applying the curve sets of curve evaluator block 402 to the input components of input transform 404 in a component-by-component basis.

A process of applying a plurality of curve sets of curve evaluator 402 to input transform 404 to generate output transform 408 can be written as y=f(x), where bold-face type indicates multiple components, such as those of a vector, matrix, or component listing. Here, x represents input transform 404, f represents curve evaluator 402, and y represents output transform 408. In a component-by-component basis, a process of applying curve sets of curve evaluator block 402 to input transform 404 to generate output transform 408 can be written as y=f(x), where “x” represents a value of a single component of input transform 404, such as those listed in transform components 406. “f” represents a parametric curve function. In particular, “f” can represent a single curve, a set of multiple curves, or a single composite curve constructed from multiple curves. In the case of piece-wise/finite-range functions such as a line-segment, “f” can include an identity function outside a range of a piece-wise function (if there is no other curve applied at end-points of the line segment), as described below. “y” represents a value of a single component of output transform 408, such as those listed in transform components 410. The output transform can include a display output transform for primary content and can include an output transform for separate, secondary content. In various embodiments, a programmer or application (API) can define specific component associations between “y” and “x” by applying parametric curves via a DM module. Such component associations are represented by “f”. If no curve is specified for a particular component, an identity function can be used (e.g., y=x).

Multiple curves can be applied to a single transform matrix component. Such multiple curves can include an array of parametric curve behavior objects. For example, multiple curves 1, 2 . . . n of the scale X curve set of curve evaluator 402 are applied to single transform matrix component scale X in FIG. 4. Such multiple curves can overlap or be disjointed. Individual curves can specify individual portions (or portion) of a composite single curve, y=f(x), as described below. This allows for generating curves based, at least in part, on curve portions provided by a variety of sources, such as a custom library stored in memory.

In various embodiments, applying curve sets of curve evaluator block 402 to input transform 404 to generate output transform 408 in a component-by-component basis, can include the following example expressions:

OutputZoomCenterX=f(InputZoomCenterX), where f represents a parametric curve for zoom center-point x and/or y.

OutputZoomCenterY=f(InputZoomCenterY), where f represents a parametric curve for zoom center-point x and/or y.

OutputZoomX=f(InputZoomX), where f represents a parametric curve for zoom factor x and/or y.

OutputZoomY=f(InputZoomY), where f represents a parametric curve for zoom factor x and/or y.

OutputRotationAngle=f(InputRotationAngle), where f represents a parametric curve for rotation.

OutputSkewAngleX=f(InputSkewAngleX) where f represents a parametric curve for skew angles.

OutputSkewAngleY=f(InputSkewAngleY) where f represents a parametric curve for skew angles.

OutputTranslationX=f(InputTranslationX), where f represents a parametric curve for translation of x and/or y components.

OutputTranslationY=f(InputTranslationY), where f represents a parametric curve for translation of x and/or y components.

Here, InputZoomCenterX, InputZoomCenterY, InputZoomX, InputZoomY, InputRotationAngle, InputSkewAngleX, InputSkewAngleY, InputTranslationX, and InputTranslationY are transform components of input transform 404. OutputZoomCenterX, OutputZoomCenterY, OutputZoomX, OutputZoomY, OutputRotationAngle, OutputSkewAngleX, OutputSkewAngleY, OutputTranslationX, and OutputTranslationY are transform components of output transform 408.

Accordingly, an output transform 408 can be expressed as a matrix based, at least in part, on a number of individual components, such as those listed above. For example, an output transform can be expressed as:

OutputMatrix=ZoomMatrix(OutputZoomCenterX,outputZoomCenterY,OutputZoomX,OutputZoomY)*RotationMatrix(RotationAngle)*SkewMatrix(SkewX,SkewY)*TranslationMatrix(OutputTranslationX,OutputTranslationY).

In some embodiments, one or more of the rotation, skew, or zoom transform components can be removed.

Such an output matrix resulting from one behavior can be chained to the next behavior as input, and so on, to obtain a final output matrix across all behaviors. For example, returning to FIG. 3, an output matrix resulting from applying curve behavior-1 object to a matrix representing input manipulation transform 308 can be chained to the next curve behavior-2 object as input, and so on, to obtain a final output matrix that represents output content transform 306, which is responsive to all behaviors included in curve evaluator 302.

Primary content can provide default overpan/overbounce manipulation and inertia curves, though an API user can override regions that would lead to overpan/overbounce. An API user can provide updated overpan/overbounce curves so that a DM module can automatically apply new custom overpan curves for an overpan region, and apply a default one-to-one linear identity curve elsewhere (e.g., where there is no custom curve specified). Default overpan/overbounce curves inside of the DM module can be considered yet another manipulation behavior as if supplied from a source external to the DM module, such as from an API. However, there is no chaining of default manipulation behavior associated with overpan/overbounce. Custom parametric equations representing manipulation behavior can be added prior to the default manipulation behavior. Accordingly, either the custom parametric manipulation behaviors' overpan curve is used or the default overpan curve is used, but not both.

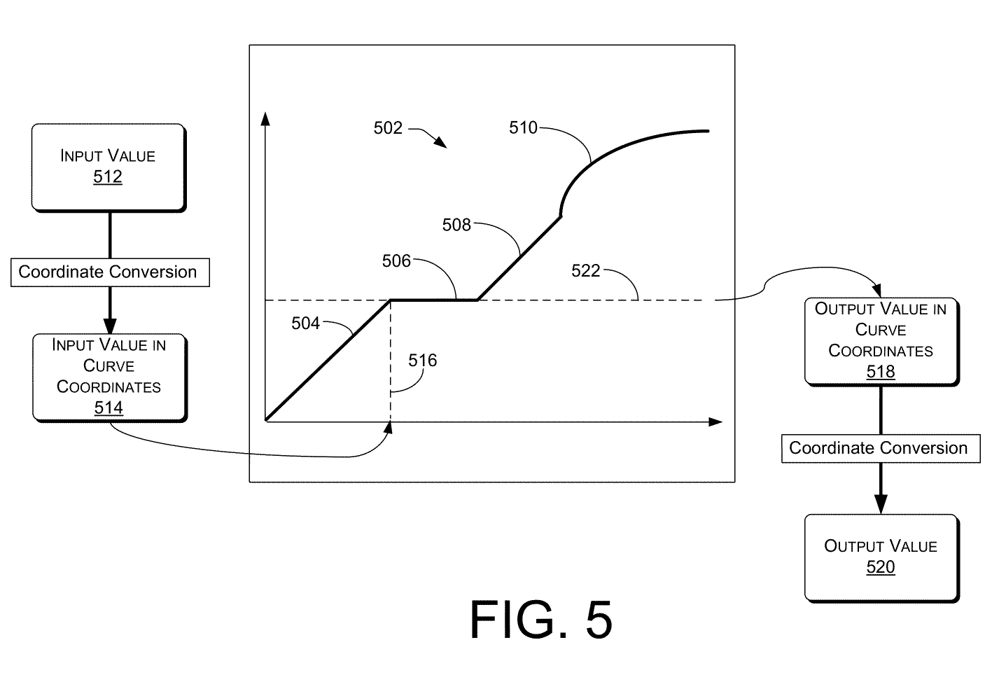

FIG. 5 shows a plot of output values (vertical axis) for a component of an output transform matrix as a function of input values (horizontal axis) of the corresponding component of an input transform matrix. For example, input values are based, at least in part, on values of a single component of a decomposed input transform matrix that in various instances can be scaled and/or un-scaled. A coordinate conversion maps the scaled or un-scaled input values to input values with specified scaled and/or un-scaled offsets. This mapping process facilitates maintenance of the application of a single curve even when a user is actively zooming primary content. Active zooming would otherwise prevent re-application or re-construction of curves as the zoom changes, be it asynchronously or synchronously. Output values include output of a parametric curve 502 based, at least in part, on input values that map to output transform component values. A coordinate conversion is used to compute final output transform component values by applying specified scaled and/or un-scaled offsets. For example, parametric curve 502 can map translation-X values from and input transform to translation-X values of the corresponding output transform.

In some embodiments, parametric curve 502 comprises a composite curve constructed from multiple curves that individually represent behavior of manipulable content, according to various embodiments. The single composite curve can be described or constructed using a set of primitives such as line-segments 504 through 508, cubic 510, and any other similar parametrically definable curves. For example, curve sets of curve evaluator 402 shown in FIG. 4 can further include a plurality of curve portions, such as the curve portions labeled curve 1, curve 2 . . . and curve n for the scale X curve set. Curve 1 through curve n can correspond to curve portions 504 through 510, respectively, which can be combined into a single composite curve 502.

A set of curves (which may include merely one curve in some cases) associates each of an input transform's components (e.g. translation, zoom) to each of an output transform's components (e.g. translation, zoom) by evaluating y=f(x) for the individual components. If a curve is not specified at a certain point, say x1, (e.g. if the curve is a finite line-segment), then the identity function can be used so that y=x1.

Such a set of curves can be constructed using different coordinate systems, so that the curves comply with a correct zoom-factor set on the manipulable content as well as any offsets based on the size of a viewport of the content or the content itself.

The curves can also include ‘gaps’ or ‘holes’ that are automatically filled in by a DM module: An API user need only specify relevant portions. For example, default overpan/overbounce manipulation/inertia curves can be filled in automatically if an API user does not specify any curve in an overpan region of the manipulable content. “Overpan” refers to a manipulation behavior of content that provides visual feedback that the content (or a portion thereof) is at a boundary as the user input indicates an attempt to move the content past the boundary. Overbounce is a spring-like motion animation of content that provides visual feedback to indicate that the user input has moved the content past a boundary and then the content bounces back to the boundary.

An application (e.g., an API) and/or programmer can describe and construct one or more curves using a parametric motion object created and obtained from a DM module. This object stores primitives, such as cubic-primitive, line-segments, and other parametric curves, associated with a single composite curve.

An application can provide multiple piece-wise discontinuous curves where the discontinuities are automatically filled in by a DM module (e.g., using the default identity curve). Such an application can also allow curves from various libraries to fill in gaps between or among discontinuous curves. Accordingly, an application need only specify values of portions of curves while leaving values of the unspecified portions to be determined using other curves or by the DM module using the default identity curve.

For example, a continuous, infinite curve can be ‘stopped’ using a piecewise curve. The continuous, infinite curve can be conjoined with the piecewise curve so that one part of the infinite curve is bounded by the piecewise curve. Order of the curves need not matter. However, if there are two curves that overlap, the curve specified last can override the other curve. In various embodiments, each curve includes a begin-offset that helps explicitly resolve such an overlap. The curve with the lowest begin-offset that is higher than the input value “x” is used as the curve “f” to evaluate y=f(x).

As another example, if there are two curves with the same begin-offset, the curve specified last is used as the curve ‘“f” to evaluate y=f(x) for all values x>beginOffset and the curve specified first is used to evaluate all values x<=beginOffset. This can be important when specifying two curves, one curve being a continuous, infinite curve that needs to be bounded on one side by a piecewise curve. Both these curves can have the same begin-offset and the order in which they are specified determines whether the infinite curve is unbounded on the left or right side of the piecewise curve.

An application or programmer can apply curves portions or a composite curve asynchronously with manipulable content, and are not expected or required to be modified by the application or programmer during a zoom operation to accommodate zoom factor changes. Thus, the curves need only be rescaled (e.g., automatically by the application) when the zoom factor changes. Each curve specifies a coordinate system offset during a curve application process that allows such automatic rescaling in the presence of a zoom factor. A non-scaled offset is an offset that can be applied to “x” input values for curve-primitives in a parametric curve object without any scale factor. A scaled offset is an offset that can be applied with the zoom-factor to manipulable content (which can also have its own associated parametric curves). Zoom-behavior determines if an entire composite curve is specified in the coordinate-system of the manipulable content. If so, the curve can automatically be scaled by the zoom-factor (which can also have its own associated parametric curves).

### Illustrative Processes

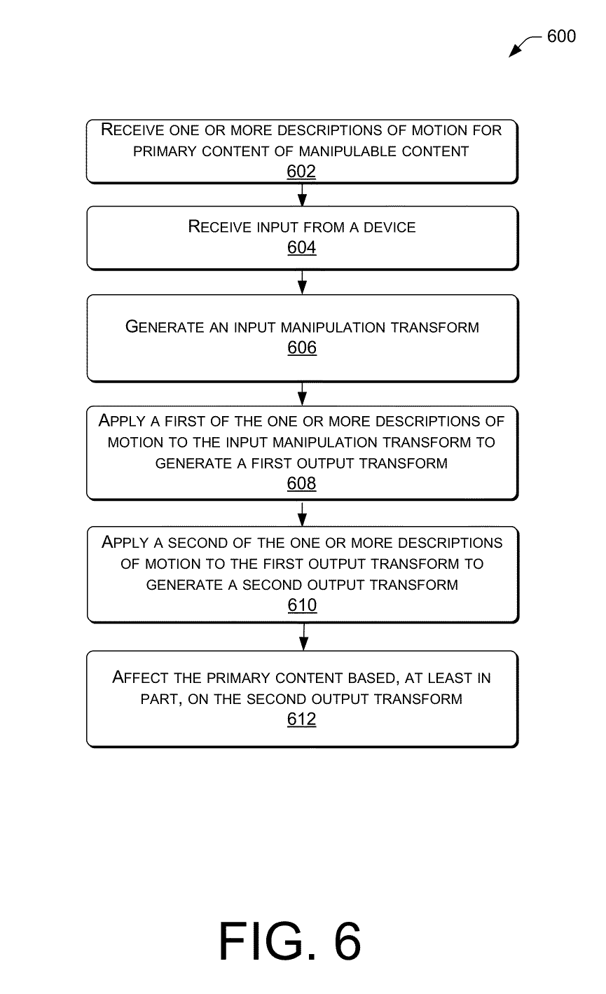

FIGS. 6, 7, and 8 illustrate example processes 600 and 700 for employing the techniques described herein. For ease of illustration processes 600 and 700 are described as being performed in the context of FIGS. 1-5. For example, one or more of the individual operations of the processes 600 and/or 700 may be performed by the device 102. However, processes 600 and 700 may be performed in other architectures.

The processes 600 and 700 (as well as each process described herein) are illustrated as a logical flow graph, each operation of which represents a sequence of operations that can be implemented in hardware, software, or a combination thereof. In the context of software, the operations represent computer-executable instructions stored on one or more computer storage media that, when executed by one or more processors, configure a device to perform the recited operations. Generally, computer-executable instructions include routines, programs, objects, components, modules, data structures, and the like that perform particular functions or implement particular abstract data types. The order in which the operations are described is not intended to be construed as a limitation, and any number of the described operations can be combined in any order and/or in parallel to implement the process. Further, any of the individual operations may be omitted.

FIG. 6 is a flow diagram of a process 600 for modifying manipulable content, according to various embodiments. Such a process can be performed by a DM module (as for the present example embodiment) or other executable code and/or hardware logic. At block 602, a DM module receives one or more descriptions of motion for primary content of manipulable content. At block 604, the DM module receives input, such as touch input, from a device, such as a touch input device. At block 606, the DM module generates an input manipulation transform based, at least in part, on the input. At block 608, the DM module applies a first of the one or more descriptions of motion to the input manipulation transform to generate a first output transform. At block 610, the DM module applies a second of the one or more descriptions of motion to the first output transform to generate a second output transform. At block 612, the DM module affects the primary content based, at least in part, on the second output transform.

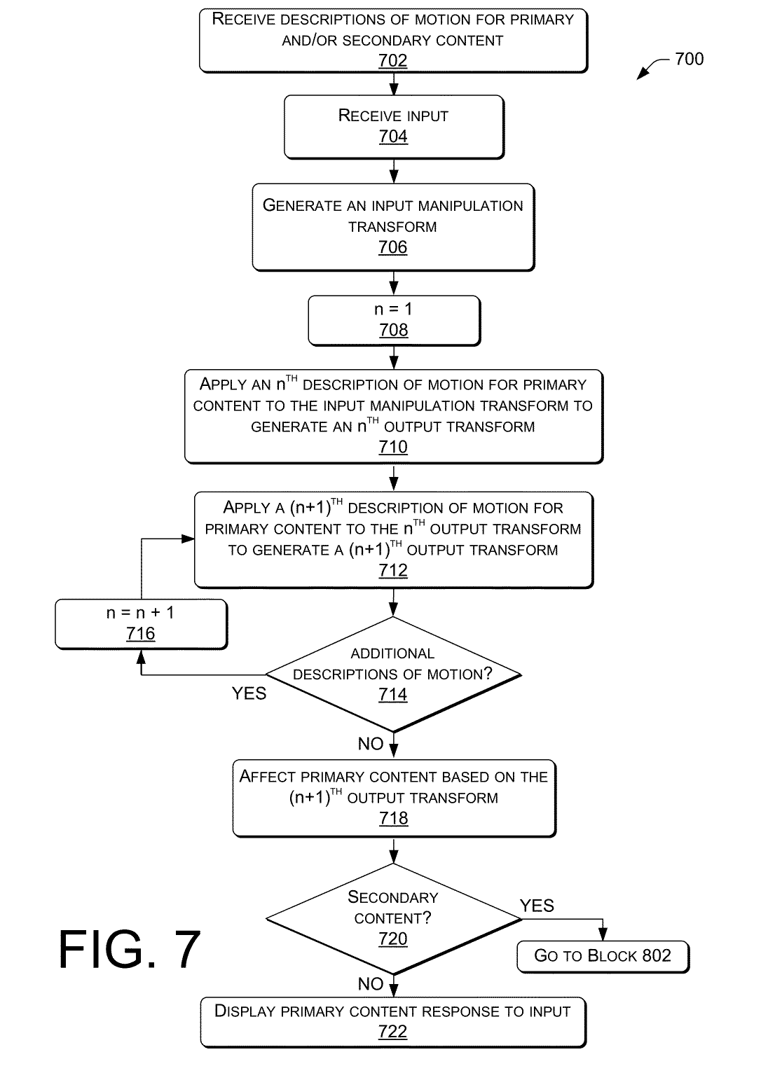

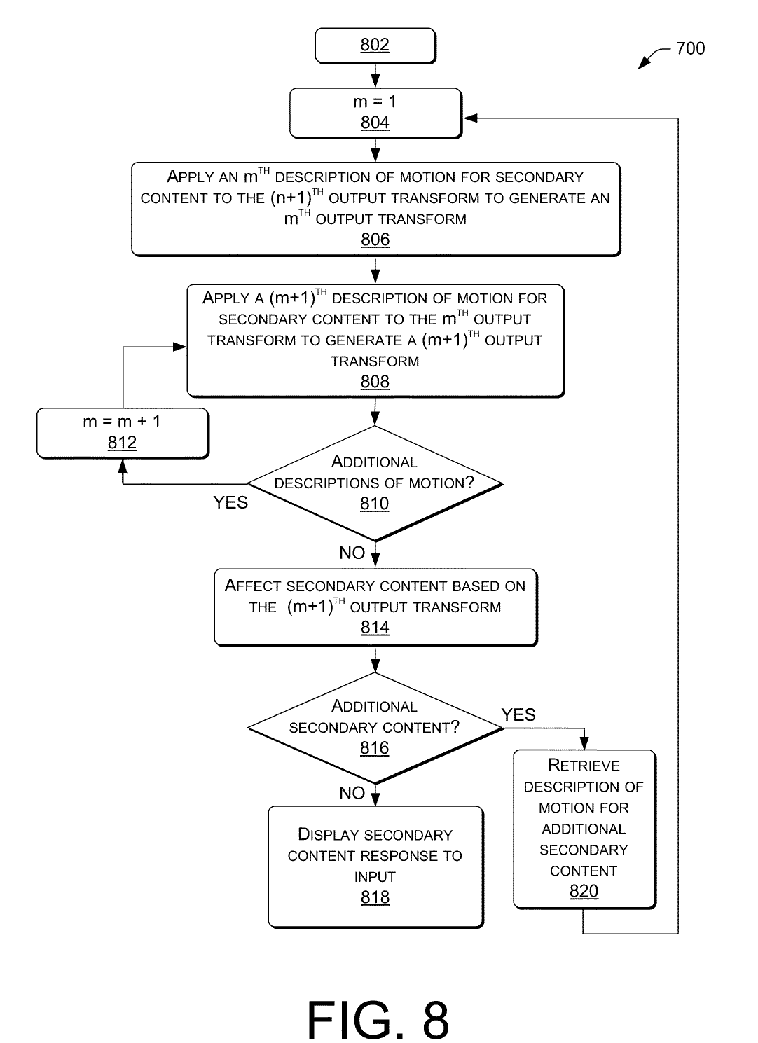

FIGS. 7 and 8 are flow diagrams of a process 700 for modifying manipulable content, according to various embodiments. Such a process can be performed by a DM module (as for the present example embodiment) or other executable code and/or hardware logic. At block 702, a DM module receives one or more descriptions of motion for primary content and/or secondary content of manipulable content. These descriptions of motion can be provided via an application programming interface (API), generated by an application, provided by a programmer, and/or generated by a portion of the DM module. At block 704, the DM module receives input, such as touch input, associated with a device, such as an input device, displaying the manipulable content. For example, touch input may include input from a touch pad, touch screen, or any other type of digitizer configured to receive touch input. At block 706, the DM module generates an input manipulation transform based, at least in part, on the input, such as touch input.

The one or more descriptions of motion for primary content received at block 702 correspond to pre-defined behaviors of the primary content, which are applied in a sequential fashion, as follows. Block 708 sets an initial condition for index n, which is used in the following portions of process 700. At block 710, a first of the one or more descriptions of motion for primary content is applied to the input manipulation transform to generate a first output transform. At decision block 714, the DM module determines how process 700 proceeds based, at least in part, on whether additional descriptions of motion for primary content were received at block 702. If so, then process 700 proceeds to block 716, which increments index n. Next, process 700 returns to block 712 where a second of the one or more descriptions of motion for primary content is applied to the first output transform to generate a second output transform. Again, at decision block 714, the DM module determines how process 700 proceeds based, at least in part, on whether additional descriptions of motion for primary content were received at block 702. If so, then process 700 again proceeds to block 716, which increments index n. Next, process 700 again returns to block 712 where a third of the one or more descriptions of motion for primary content is applied to the second output transform to generate a third output transform.

After all descriptions of motion for primary content received at block 702 have been sequentially applied (in blocks 710 and 712), process 700 proceeds from decision block 714 to block 718, where the DM module affects primary content based, at least in part, on the last output transform generated in block 712. At decision block 720, the DM module determines whether manipulable content includes secondary content in addition to the primary content. If not, then process 700 proceeds to block 722 where the DM module displays primary content response to input, such as touch input, received at block 704. On the other hand, process 700 proceeds to block 802 in FIG. 8 if secondary content exists.

Similar to the case for primary content, the one or more descriptions of motion for secondary content received at block 702 correspond to pre-defined behaviors of the secondary content, which are applied in a sequential fashion, as follows. Block 804 sets an initial condition for index m, which is used in the following portions of process 700. At block 806, a first of the one or more descriptions of motion for secondary content is applied to the last output transform generated in block 712 to generate a first output transform for secondary content. At block 808, a second of the one or more descriptions of motion for secondary content is applied to the first output transform generated in block 806 to generate a second output transform for secondary content. At decision block 810, the DM module determines how process 700 proceeds based, at least in part, on whether additional descriptions of motion for secondary content were received at block 702. If so, then process 700 proceeds to block 812, which increments index m. Next, process 700 returns to block 808 where a third of the one or more descriptions of motion for primary content is applied to the second output transform for secondary content to generate a third output transform. At decision block 810, the DM module determines how process 700 proceeds based, at least in part, on whether additional descriptions of motion for secondary content were received at block 702. If so, then process 700 again returns to block 808 after incrementing index m at block 812. However, if all descriptions of motion for secondary content received at block 702 have been sequentially applied (in blocks 806 and 808), process 700 proceeds from decision block 810 to block 814, where the DM module affects secondary content based, at least in part, on the last output transform generated in block 808.

Descriptions of motion may be directed to primary content and/or secondary content. The secondary content received at block 702, however, can include one or more individual secondary contents, each with its own corresponding descriptions of motion. As described with respect to FIG. 3, this is shown by the multiple blocks “Secondary Content 1”, “Secondary Content 2”, and “Secondary Content q”. Thus, a first of multiple secondary contents (e.g., “Secondary Content 1”) is treated in process 700 the first time through blocks 806 through 814. A second of multiple secondary contents (e.g., “Secondary Content 2”) is treated in process 700 the second time through blocks 806 through 814, and so on.

Accordingly, at decision block 816, the DM module determines whether additional secondary content exists. If not, then process 700 proceeds to block 818 where the DM module displays secondary content response to input, such as touch input, received at block 704. If additional secondary content does exists, then process 700 proceeds to block 820 where descriptions of motion for the additional secondary content can be retrieved from memory, where they were stored from the time they were received at block 702. Process 700 then returns to block 804 to repeat the process of blocks 806 through 814 for the subsequent secondary content.

### CONCLUSION

Although the techniques have been described in language specific to structural features and/or methodological acts, it is to be understood that the appended claims are not necessarily limited to the features or acts described. Rather, the features and acts are described as example implementations of such techniques.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are otherwise understood within the context as used in general to present that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the embodiments described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system comprising:
an input device to receive input from a user;
one or more processors communicatively coupled to the input device;
memory communicatively coupled to the one or more processors;
a graphics module stored in the memory and executable by the one or more processors;
a display responsive to the graphics module; and
a direct manipulation module stored in the memory and executable by the one or more processors to perform operations comprising:
applying a set of parametric equations to an input transform to generate an output transform; and
providing instructions to the graphics module to affect represented motion of manipulable content on the display responsive to the input received from the input device based, at least in part, on the output transform.

2. The system of claim 1, wherein the direct manipulation module is further executable to chain multiple pre-defined behaviors of the manipulable content so that an output transform of one of the multiple pre-defined behaviors comprises an input transform of a next one of the multiple pre-defined behaviors.

3. The system of claim 2, wherein the manipulable content comprises primary content, and wherein the direct manipulation module is further executable to:
responsive to the input, apply a pre-defined behavior of secondary manipulable content to a final output transform of the chained multiple pre-defined behaviors of the primary content; and
responsive to the input, affect motion of the secondary manipulable content based, at least in part, on the applied pre-defined behavior of secondary manipulable content.

4. The system of claim 1, wherein the input transform is responsive to touch input received by the input device.

5. The system of claim 1, wherein the input transform is based, at least in part, on time-based animation behavior while there is no touch input from a user to the input device.

6. The system of claim 1, wherein the set of parametric equations corresponds to a pre-defined behavior of the manipulable content.

7. A computer-readable storage medium storing computer-executable instructions that, when executed by a processor, configure the processor to perform operations comprising:
applying a set of parametric equations to an input transform to generate an output transform; and
affecting motion of manipulable content of an input device on a display based, at least in part, on the output transform.

8. The computer-readable storage medium of claim 7, wherein the set of parametric equations corresponds to a pre-defined behavior of the manipulable content.

9. The computer-readable storage medium of claim 7, further comprising chaining multiple pre-defined behaviors of the manipulable content so that an output transform of one of the multiple pre-defined behaviors comprises an input transform of a next one of the multiple pre-defined behaviors.

10. The computer-readable storage medium of claim 9, wherein the manipulable content comprises primary content, and further comprising:
applying pre-defined behavior of secondary manipulable content of the input device to a final output transform of the chained multiple pre-defined behaviors of the primary content; and
affecting motion of the secondary manipulable content of the input device on the display based, at least in part, on the applied pre-defined behavior of secondary manipulable content.

11. The computer-readable storage medium of claim 7, wherein the input device includes a touch input device and the input transform is responsive to touch input from the touch input device.

12. The computer-readable storage medium of claim 7, wherein the input transform is based, at least in part, on time-based animation behavior while there is no active input from the input device.

13. The computer-readable storage medium of claim 7, further comprising combining the set of parametric equations into a single composite equation that corresponds to the pre-defined behavior of the manipulable content.

14. The computer-readable storage medium of claim 7, further comprising controlling the display by controlling communication between a direct manipulation module and a graphics module.

15. A method comprising:
receiving one or more descriptions of motion for primary content of manipulable content;
receiving input from an input device;
generating an input manipulation transform based, at least in part, on the input;
applying a first of the one or more descriptions of motion to the input manipulation transform to generate a first output transform;
applying a second of the one or more descriptions of motion to the first output transform to generate a second output transform; and
affecting the primary content based, at least in part, on the second output transform.

16. The method of claim 15, further comprising:
receiving descriptions of motion for each of one or more secondary contents of the manipulable content;
applying the descriptions of motion for each of the one or more secondary contents of the manipulable content to the second output transform to respectively generate a set of third output transforms; and
affecting the one or more secondary contents based, at least in part, on the set of third output transforms.

17. The method of claim 15, wherein the one or more descriptions of motion each comprise parametric equations.

18. The method of claim 15, wherein the one or more descriptions of motion for primary content are applied asynchronously with receiving the input manipulation transform.

19. The method of claim 15, further comprising modifying any of the one or more descriptions of motion for the primary content.

20. The method of claim 15, wherein the input device is capable of providing motion to an object of the manipulable content presented visually on an output device.
